(19) United States
(12) Patent Application Publication
(10) Pub. No.: US 2021/0276174 A1
(43) Pub. Date: Sep. 9, 2021

(54) Locking Tool Extension Apparatus and Painting Tool Assembly

(71) Applicant: Ronald Davis, Houston, TX (US)

(72) Inventor: Ronald Davis, Houston, TX (US)

(21) Appl. No.: 16/807,668

(22) Filed: Mar. 3, 2020

(51) Int. Cl. B25G 3/30; B05C 17/02; A46B 5/00; B44D 3/16; B25G 1/04

(52) U.S. Cl. CPC B25G 3/30; B05C 17/0205; A46B 5/002; A46B 2200/202; B44D 3/162; B25G 1/04; A46B 5/0095

(57) ABSTRACT

A locking tool extension apparatus and painting tool assembly for preventing threaded tool handles from loosening on an extension pole includes a plurality of painting tools having a threaded female handle aperture. An extension pole has a threaded male pole end coupled to a pole top side. A locking tool extension apparatus comprises a sleeve body having a threaded female receiving. The female receiving aperture selectively receives the threaded male pole end of the extension pole. A threaded male extension end is coupled to the sleeve body. The male extension end is selectively engageable with the threaded female handle aperture of the tool handle. A first spring lock washer is coupled to the sleeve body. The first spring lock washer prevents the tool handle from unintentionally loosening on the male extension end.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tool extension devices and more particularly pertains to a new tool extension device for preventing threaded tool handles from loosening on an extension pole.

### (2) Description of Related Art Including Information Disclosed Under 37 CFR 1.97 and 1.98

The prior art relates to tool extension devices.

### BRIEF SUMMARY OF THE INVENTION

An embodiment of the disclosure meets the needs presented above by generally comprising a plurality of painting tools comprising a paint brush, a paint roller, and a paint scraper. Each of the painting tools has a tool handle having a threaded female handle aperture. An extension pole has a threaded male pole end coupled to a pole top side. A locking tool extension apparatus comprises a sleeve body having a sleeve top side, a sleeve sidewall, and a sleeve bottom side. The sleeve bottom side has a threaded female receiving aperture extending towards the sleeve top side. The female receiving aperture selectively receives the threaded male pole end of the extension pole. A threaded male extension end is coupled to the sleeve body. The male extension end is centrally coupled to the sleeve top side. The male extension end is selectively engageable with the threaded female handle aperture of the tool handle. A first spring lock washer is coupled to the sleeve body. The first spring lock washer is coupled to the sleeve top side around the male extension end. The first spring lock washer prevents the tool handle from unintentionally loosening on the male extension end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded view of a locking tool extension apparatus and painting tool assembly according to an embodiment of the disclosure.

FIG. 2 is an isometric view of an embodiment of the disclosure.

FIG. 3 is an isometric view of an embodiment of the disclosure.

FIG. 4 is an isometric view of an embodiment of the disclosure.

FIG. 5 is a cross-sectional view along the line 5-5 of FIG. 4 of an embodiment of the disclosure.

### DETAILED DESCRIPTION OF THE INVENTION

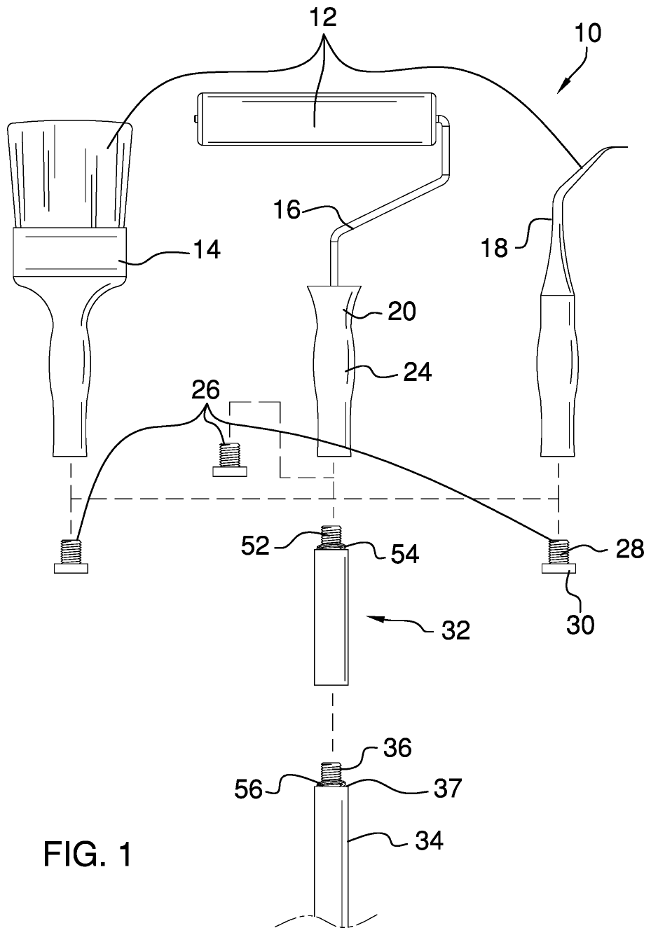

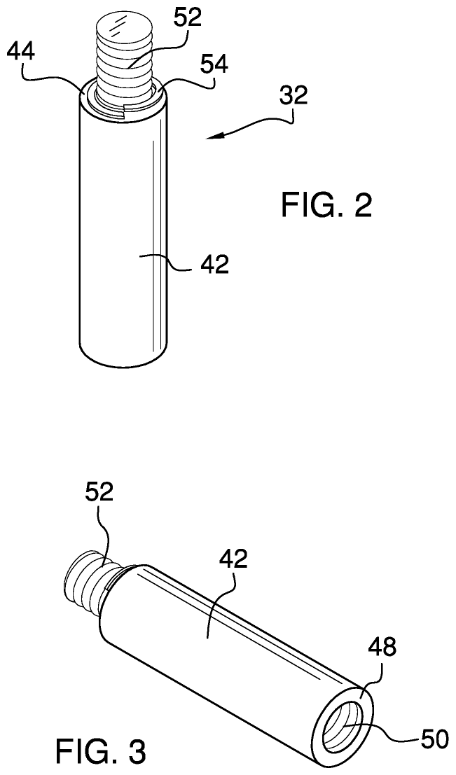

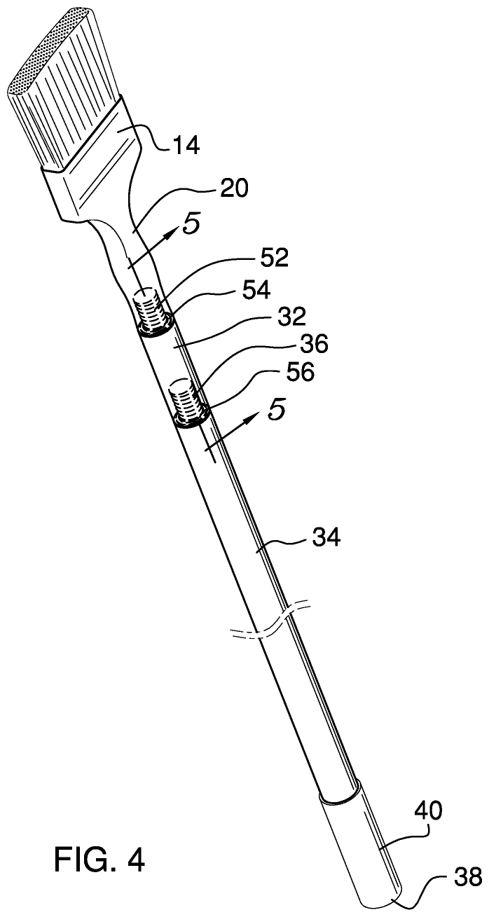

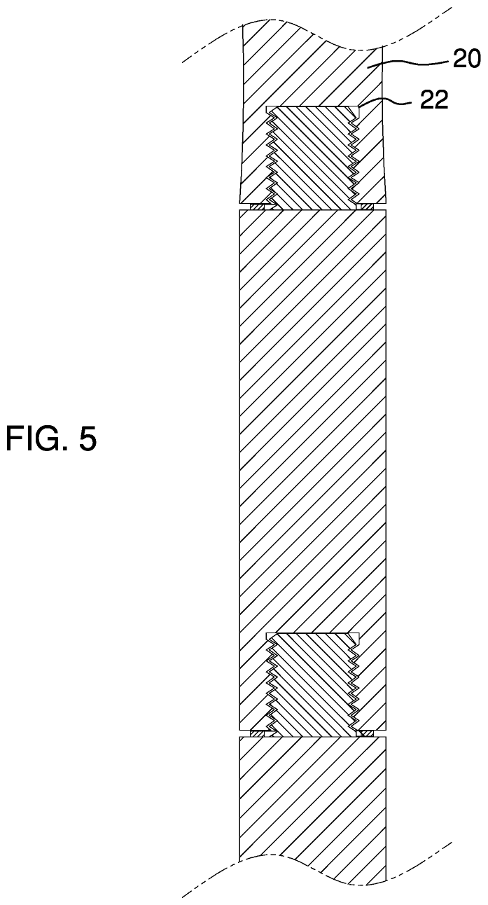

With reference now to the drawings, and in particular to FIGS. 1 through 5 thereof, a new tool extension device embodying the principles and concepts of an embodiment of the disclosure and generally designated by the reference numeral 10 will be described.

As best illustrated in FIGS. 1 through 5, the locking tool extension apparatus and painting tool assembly 10 generally comprises a plurality of painting tools 12 comprising a paint brush 14, a paint roller 16, and a paint scraper 18. Each of the painting tools 12 has a tool handle 20 having a threaded female handle aperture 22. The tool handle 20 has a bulged portion 24. A plurality of screw plugs 26 each have a threaded male plug end 28 coupled to a plug base 30. The male plug end 28 is selectively engageable with the female handle aperture 22. An extension pole 34 has a threaded male pole end 36 coupled to a pole top side 37 and a handle end 38. The extension pole 34 has a handgrip 40 coupled around the handle end 38. A locking tool extension apparatus 32 comprises a sleeve body 42 having a sleeve top side 44, a sleeve sidewall 46, and a sleeve bottom side 48. The sleeve bottom side 48 has a threaded female receiving aperture 50 extending towards the sleeve top side 44. The female receiving aperture 50 selectively receives the threaded male pole end 36 of the extension pole 34. A threaded male extension end 52 is centrally coupled to the sleeve top side 44. The male extension end 52 is selectively engageable with the threaded female handle aperture 22 of the tool handle 20 of each of the painting tools 12. A first spring lock washer 54 is coupled to the sleeve top side 44 around the male extension end 52. The first spring lock washer 54 prevents the tool handle 20 from unintentionally loosening on the male extension end 52. A second spring lock washer 56 is coupled to the pole top side 37 around the male pole end 36.

In use, the desired painting tool 12 is selected from the plurality of painting tools 12. The male plug end 28 of the sleeve top side 44 is engaged with the painting tool 12. The threaded male pole end 36 of the extension pole 34 is engaged with the female receiving aperture 50 of the sleeve bottom side 48. The first spring lock washer 54 and the second spring lock washer 56 keep the tool handle 12 and the extension pole 34 from unintentionally loosing, respectively.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A locking tool extension apparatus and painting tool assembly comprising:
a plurality of painting tools, the plurality of painting tools comprising a paint brush, a paint roller, and a paint scraper, each of the painting tools having a tool handle, the tool handle having a threaded female handle aperture;
an extension pole, the extension pole having a threaded male pole end coupled to a pole top side; and
a locking tool extension apparatus comprising:
a sleeve body, the sleeve body having a sleeve top side, a sleeve sidewall, and a sleeve bottom side, the sleeve bottom side having a threaded female receiving aperture extending towards the sleeve top side, the female receiving aperture selectively receiving the threaded male pole end of the extension pole;
a threaded male extension end coupled to the sleeve body, the male extension end being centrally coupled to the sleeve top side, the male extension end being selectively engageable with the threaded female handle aperture of the tool handle; and
a first spring lock washer coupled to the sleeve body, the first spring lock washer being coupled to the sleeve top side around the male extension end, the first spring lock washer preventing the tool handle from unintentionally loosening on the male extension end.

2. A locking tool extension apparatus comprising:
a sleeve body, the sleeve body having a sleeve top side, a sleeve sidewall, and a sleeve bottom side, the sleeve bottom side having a threaded female receiving aperture extending towards the sleeve top side, the female receiving aperture being configured to receive a threaded male pole end of an extension pole;
a threaded male extension end coupled to the sleeve body, the male extension end being centrally coupled to the sleeve top side, the male extension end being configured to be selectively engageable with a threaded female handle aperture of a tool handle; and
a first spring lock washer coupled to the sleeve body, the first spring lock washer being coupled to the sleeve top side around the male extension end, the first spring lock washer being configured to prevent the tool handle from unintentionally loosening on the male extension end.

3. The locking tool extension apparatus of claim 1 further comprising the extension pole having a handgrip coupled around a handle end.

4. The locking tool extension apparatus of claim 1 further comprising a second spring lock washer coupled to the extension pole, the second spring lock washer being coupled to the pole top side around the male pole end.

5. The locking tool extension apparatus of claim 1 further comprising the tool handle of each of the painting tools having a bulged portion.

6. The locking tool extension apparatus of claim 1 further comprising a plurality of screw plugs, each of the screw plugs having a threaded male plug end coupled to a plug base, the male plug end being selectively engageable with the female handle aperture.

7. A locking tool extension apparatus and painting tool assembly comprising:
a plurality of painting tools, the plurality of painting tools comprising a paint brush, a paint roller, and a paint scraper, each of the painting tools having a tool handle, the tool handle having a threaded female handle aperture, the tool handle having a bulged portion;
a plurality of screw plugs, each of the screw plugs having a threaded male plug end coupled to a plug base, the male plug end being selectively engageable with the female handle aperture;
an extension pole, the extension pole having a threaded male pole end coupled to a pole top side and a handle end, the extension pole having a handgrip coupled around the handle end; and
a locking tool extension apparatus comprising:
a sleeve body, the sleeve body having a sleeve top side, a sleeve sidewall, and a sleeve bottom side, the sleeve bottom side having a threaded female receiving aperture extending towards the sleeve top side, the female receiving aperture selectively receiving the threaded male pole end of the extension pole;
a threaded male extension end coupled to the sleeve body, the male extension end being centrally coupled to the sleeve top side, the male extension end being selectively engageable with the threaded female handle aperture of the tool handle of each of the painting tools;
a first spring lock washer coupled to the sleeve body, the first spring lock washer being coupled to the sleeve top side around the male extension end, the first spring lock washer preventing the tool handle from unintentionally loosening on the male extension end; and
a second spring lock washer coupled to the extension pole, the second spring lock washer being coupled to the pole top side around the male pole end.
